(19) United States
(12) Patent Application Publication
(10) Pub. No.: US 2025/0236794 A1
(43) Pub. Date: Jul. 24, 2025

(54) COMPOSITION FOR ETCHING SILICON NITRIDE LAYER

(71) Applicant: DONGWOO FINE-CHEM CO., LTD., Jeollabuk-do (KR)

(72) Inventors: KYU SANG AHN, Jeollabuk-do (KR); HYO JOONG YOON, Jeollabuk-do (KR); JIN KYU ROH, Jeollabuk-do (KR); SANG KWON KIM, Jeollabuk-do (KR)

(21) Appl. No.: 18/983,653

(22) Filed: Dec. 17, 2024

(30) Foreign Application Priority Data
Jan. 22, 2024 (KR) 10-2024-0009416
Jan. 22, 2024 (KR) 10-2024-0009417
Nov. 25, 2024 (KR) 10-2024-0169896

(51) Int. Cl. C09K 13/10

(52) U.S. Cl. CPC C09K 13/10

(57) ABSTRACT

A composition for etching a silicon nitride layer according to an embodiment includes hydrofluoric acid, a boron-containing compound or a phosphite compound, water and a protic solvent. The composition for etching a silicon nitride layer may etch the silicon nitride layer at a high speed while etching the silicon oxide layer less.

### CROSS-REFERENCE TO RELATED APPLICATION AND CLAIM OF PRIORITY

This application claims the benefit under 35 USC § 119 of Korean Patent Application Nos. 10-2024-0009417 filed on Jan. 22, 2024, 10-2024-0009416 filed on Jan. 22, 2024, and 10-2024-0169896 filed on Nov. 25, 2024, in the Korean Intellectual Property Office, the entire disclosure of which are incorporated herein by reference for all purposes.

### BACKGROUND

### 1. Field of the Invention

The present invention relates to a composition for etching a silicon nitride layer.

### 2. Description of the Related Art

A silicon nitride layer is used as a representative insulation layer in a semiconductor process. The silicon nitride layer is used alone, or used in a way that one or more silicon oxide layers and one or more of silicon nitride layers are alternately laminated. In addition, the silicon oxide layer and the silicon nitride layer are also used as hard masks for forming conductive patterns such as a metal line.

In general, phosphoric acid is used to etch the silicon nitride layer. However, when etching by increasing a temperature of the phosphoric acid to increase an etching rate, since the etching rate of the silicon oxide layer is increased along with the etching rate of the silicon nitride layer, there is a problem that selectivity is reduced.

In order to increase the etching selectivity for the silicon nitride layer, a method of controlling the etching rate for the silicon oxide layer by using phosphoric acid and a silane compound together in an etching composition has been proposed. However, a silanol group is formed from the silane compound, such that the surrounding alkoxysilane compounds may be aggregated together to cause gelation.

In addition, when performing an etching process at a high temperature, a phenomenon of boiling of the etching composition may occur to evaporate components in the etching composition. Accordingly, there are problems that the composition of the etching composition may be changed during performing the etching process, thereby causing gelation or a decrease in the etching rate, and the selectivity for the silicon nitride layer may be decreased.

Therefore, there is a need to develop an etching composition which does not cause gelation of the etching composition, allows the process to be performed at a relatively low temperature, and does not cause a change in the composition of the etching composition during the etching process, thereby providing a high selectivity for the silicon nitride layer.

### SUMMARY

An object of the present invention is to provide a composition for etching a silicon nitride layer, which may implement a high etching rate.

To achieve the above objects, the following technical solutions are adopted in the present invention.

1. A composition for etching a silicon nitride layer including: hydrofluoric acid; a boron-containing compound or a phosphite compound; water; and a protic solvent.

2. The composition for etching a silicon nitride layer according to the above 1, wherein the phosphite compound is represented by Formula 1 below:

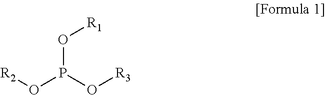

(in Formula 1, R₁ to R₃ are each independently hydrogen, an alkyl group having 1 to 10 carbon atoms, an aryl group having 6 to 10 carbon atoms, or an alkylaryl group having 7 to 20 carbon atoms).

3. The composition for etching a silicon nitride layer according to the above 2, wherein in the Formula 1, R₁ to R₃ are each independently hydrogen or an alkyl group having 1 to 4 carbon atoms.

4. The composition for etching a silicon nitride layer according to the above 2, wherein in the Formula 1, R₁ to R₃ are the same as each other.

5. The composition for etching a silicon nitride layer according to the above 1, wherein a content of the phosphite compound is 0.1% by weight to 10% by weight based on a total weight of the composition.

6. The composition for etching a silicon nitride layer according to the above 1, wherein a content of the phosphite compound is 0.5% by weight to 5% by weight based on a total weight of the composition.

7. The composition for etching a silicon nitride layer according to the above 1, wherein the boron-containing compound includes a borate compound.

8. The composition for etching a silicon nitride layer according to the above 1, wherein the boron-containing compound is represented by Formula 2 below:

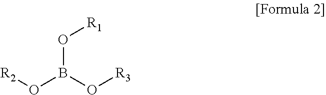

(in Formula 2, R₁ to R₃ are each independently hydrogen, an alkyl group having 1 to 10 carbon atoms, or an aryl group having 6 to 10 carbon atoms).

9. The composition for etching a silicon nitride layer according to the above 8, wherein in the Formula 2, R₁ to R₃ are each independently hydrogen or an alkyl group having 1 to 4 carbon atoms.

10. The composition for etching a silicon nitride layer according to the above 8, wherein in the Formula 2, R₁ to R₃ are the same as each other.

11. The composition for etching a silicon nitride layer according to the above 1, wherein a content of the boron-containing compound is 0.01% by weight to 5% by weight based on a total weight of the composition.

12. The composition for etching a silicon nitride layer according to the above 1, wherein a content of the boron-containing compound is 0.1% by weight to 3% by weight based on a total weight of the composition.

13. The composition for etching a silicon nitride layer according to the above 1, wherein the protic solvent has a conductivity of 10 μS/cm or less, and the conductivity is measured on a solution in which 1% by weight of hydrofluoric acid is dissolved in the protic solvent.

14. The composition for etching a silicon nitride layer according to the above 1, wherein the protic solvent has a boiling point of 80° C. or higher.

15. The composition for etching a silicon nitride layer according to the above 1, wherein the protic solvent includes an alcohol solvent.

16. The composition for etching a silicon nitride layer according to the above 1, wherein a content of the hydrofluoric acid is 0.1% by weight to 10% by weight based on a total weight of the composition.

17. The composition for etching a silicon nitride layer according to the above 1, wherein a content of the water is 0.5% by weight to 10% by weight based on a total weight of the composition.

18. The composition for etching a silicon nitride layer according to the above 1, wherein a ratio of a content of hydrofluoric acid to a content of water in the total weight of the composition is 0.1 to 1.5.

19. The composition for etching a silicon nitride layer according to the above 1, wherein the composition does not include a silicon compound.

20. The composition for etching a silicon nitride layer according to the above 1, wherein the composition does not include a basic compound.

The composition for etching a silicon nitride layer according to exemplary embodiments of the present invention may be used to etch the silicon nitride layer at a high speed.

In addition, the composition for etching a silicon nitride layer may include a boron-containing compound or a phosphite compound to selectively etch the silicon nitride layer. Accordingly, the composition for etching a silicon nitride layer may be used to etch the silicon nitride layer relatively more than the silicon oxide layer.

### DETAILED DESCRIPTION OF THE INVENTION

According to exemplary embodiments of the present disclosure, there is provided a composition for etching a silicon nitride layer which includes hydrofluoric acid, a boron-containing compound or a phosphite compound, water and a protic solvent.

Hereinafter, the present disclosure will be described in detail through embodiments. However, the embodiments are merely illustrative and the present disclosure is not limited to the specific embodiments described by way of example.

The hydrofluoric acid (HF) may function as an etching species as a weak acid compound. The hydrofluoric acid may function as an etching species as HF in the composition for etching a silicon nitride layer (hereinafter, may be abbreviated as a “composition”) or may form HF₂⁻ ion species as an etching species. Fluorine-containing compounds which are different from the hydrofluoric acid may function as an etching species only when they are hydrated to become ions or form HF through other reactions, but the hydrofluoric acid may form HF₂⁻ by itself or easily ionized, and thus may be suitable as an etching species of the composition.

The HF₂⁻ ion species formed by ionization of hydrofluoric acid may etch the silicon oxide layer, and the hydrofluoric acid (HF) may etch the silicon nitride layer. Since the hydrofluoric acid is ionized into HF₂⁻ in an aqueous solvent, when the composition includes an aqueous solvent, etching for the silicon nitride layer may be relatively small, such that it is preferable to suppress the formation of HF₂⁻ ion species. Accordingly, the composition may include a protic solvent to be described below as a main solvent.

For example, fluorine-containing compounds (e.g., LiF, NaF, KF, NH₄F, etc.) having small molecular weights and different from the hydrofluoric acid have a problem that they are not dissolved in an organic solvent due to strong bonding between cations and F. In addition, fluorine-containing compounds (e.g., tetraalkylammonium fluoride, etc.) having relatively large molecular weights and different from the hydrofluoric acid are soluble in the organic solvent, but have a problem that, because the molecular volume thereof is too large, it is difficult for a fluorine-containing etching species to react with the silicon nitride layer due to steric hindrance, and thus does not exhibit desired etching performance.

A content of the hydrofluoric acid may be 0.1% by weight (“wt %”) to 10 wt % based on a total weight of the composition. In some embodiments, the content thereof may be 0.5 wt % to 5 wt %, or 1 wt % to 3 wt % based on the total weight of the composition.

Within the above range, the composition may etch the silicon nitride layer more than the silicon oxide layer while also having an appropriate etching rate for the silicon nitride layer.

Conventionally, a phosphate compound (e.g., phosphoric acid) was used as a silicon etching species in an etchant composition. However, the phosphate compound includes an oxygen atom bonded to a phosphorus atom by a double bond and three oxygen atoms bonded to the phosphorus atom by a single bond, such that the phosphorus atom does not have an unshared electron pair. Accordingly, the phosphate compound have a problem that not only silicon but also the silicon oxide and/or silicon nitride layer was oxidized. The phosphite compound may include three oxygen atoms bonded to the phosphorus atom by a single bond. Accordingly, the phosphorus atom may have an unshared electron pair. The unshared electron pair may be bonded to silicon through a nucleophilic reaction, thereby blocking contact between the silicon atom and the etching species. Accordingly, etching of the silicon oxide layer and the silicon nitride layer may be prevented, and a silicon atom of the silicon oxide layer, which has lost more electrons to oxygen having a higher electronegativity, and the unshared electron pair of the phosphorus atom may more easily perform a nucleophilic reaction. Thereby, the phosphite compound may enhance an anti-corrosion effect for the silicon oxide layer of the etchant composition and provide a high silicon etching selectivity.

The phosphite compound may reduce both the etching rates for the silicon nitride layer and the silicon oxide layer of the composition. However, the amount of reduction in the etching rate of the silicon oxide layer is greater than the amount of reduction in the etching rate of the silicon nitride layer, thus the etching rate of the silicon nitride layer may be increased relative to the etching rate of the silicon oxide layer of the composition. Accordingly, the composition may have a high selectivity.

The phosphite compound may be represented by Formula 1 below.

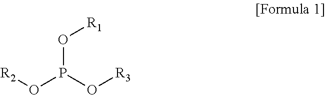

In Formula 1 above, R₁ to R₃ may each independently be hydrogen, an alkyl group having 1 to 10 carbon atoms, an aryl group having 6 to 10 carbon atoms, or an alkylaryl group having 7 to 20 carbon atoms.

The aryl group is a hydrocarbon group including at least one aromatic ring, and may be, for example, a phenyl group, a naphthalene group, a fluorene group, etc.

The alkylaryl group is a hydrocarbon group having a structure in which at least one hydrogen of the aryl group is substituted with an alkyl group, and may be, for example, an alkylphenyl group, an alkylnaphthalene group, an alkylfluorene group, etc. The alkyl group substituted with the aryl group may be an alkyl group having 1 to 10 carbon atoms.

In some embodiments, at least one of the R₁ to R₃ may be an alkyl group having 1 to 10 carbon atoms, an aryl group having 6 to 10 carbon atoms, or an alkylaryl group having 7 to 20 carbon atoms. For example, when the R₁ and R₂ are hydrogen, R₃ may not be hydrogen. Alternately, when the R₁ is hydrogen, at least one of the R₂ and R₃ may not be hydrogen. In this case, the phosphite compound may have a high stability.

In some embodiments, the R₁ to R₃ may be an alkyl group having 1 to 4 carbon atoms, and the alkyl group may have a linear shape. For example, the R₁ to R₃ may each independently be a methyl group, an ethyl group, a propyl group, an isopropyl group, a butyl group, etc.

When the R₁ to R₃ are alkyl groups having 1 to 4 carbon atoms, the phosphorus atom may not be covered by steric hindrance. Accordingly, an interaction between the unshared electron pair of the phosphorus atom and the silicon atom may be smooth, and the anti-corrosion effect for the silicon oxide layer of the composition may be improved.

The R₁ to R₃ may be the same as each other. Accordingly, the phosphite compound may have a high structural stability, and the etching of the silicon oxide layer may be further prevented.

A content of the phosphite compound may be 0.1 wt % to 10 wt % based on the total weight of the composition. According to some embodiments, the content of the phosphite compound may be 1 wt % to 6 wt %, or 2 wt % to 4 wt % based on the total weight of the composition. Within the above range, the etching rate for the silicon nitride layer may not be significantly reduced while also sufficiently preventing the etching of the silicon oxide layer by the composition.

The boron-containing compound may reduce both the etching rates of the silicon nitride layer and the silicon oxide layer of the composition. However, since the amount of reduction in the etching rate of the silicon oxide layer is greater than the amount of reduction in the etching rate of the silicon nitride layer, the etching rate of the silicon nitride layer to the etching rate of the silicon oxide layer of the composition may be increased. Accordingly, the composition may have a high selectivity.

For example, the boron-containing compound may be an ionic compound or a nonionic compound. For example, the boron-containing compound may include a metal cation and a borohydride anion. In addition, the nonionic compound may include a borate compound.

The boron-containing compound may be represented by Formula 2 below.

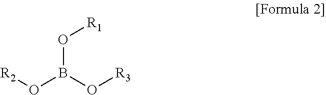

In Formula 2 above, R₁ to R₃ may each independently be hydrogen, an alkyl group having 1 to 10 carbon atoms, or an aryl group having 6 to 10 carbon atoms.

For example, when R₁ to R₃ are hydrogen, the boron-containing compound may be boric acid.

The aryl group is a hydrocarbon group including at least one aromatic ring, and may be, for example, a phenyl group, a naphthalene group, a fluorene group, etc.

In some embodiments, the R₁ to R₃ may be an alkyl group having 1 to 4 carbon atoms, and the alkyl group may have a linear shape. For example, the R₁ to R₃ may each independently be a methyl group, an ethyl group, a propyl group, an isopropyl group, a butyl group, etc.

When the alkyl group is an alkyl group having 1 to 4 carbon atoms, the boron atom may not be covered by steric hindrance. Accordingly, an interaction between the boron atom and the silicon atom may be smooth, and the anti-corrosion effect for the silicon oxide layer of the composition may be improved.

The R₁ to R₃ may be the same as each other. Accordingly, the boron-containing compound may have a high structural stability, and the etching of the silicon oxide layer may be further prevented.

A content of the boron-containing compound may be 0.01 wt % to 5 wt % based on the total weight of the composition. According to some embodiments, the content of the boron-containing compound may be 0.1 wt % to 3 wt % based on the total weight of the composition.

Within the above range, the etching rate for the silicon nitride layer may not be significantly reduced while also sufficiently preventing the etching of the silicon oxide layer by the composition.

The protic solvent may reduce the ionization of hydrofluoric acid, thereby suppressing the generation of HF₂⁻ which etches the silicon oxide layer.

In addition, in order to etch the silicon nitride layer, a step of activating the silicon nitride layer is required, and the protic solvent may improve the stability of the activation step of the silicon nitride layer. Accordingly, the etching may be smoothly performed while maintaining the activation state of the silicon nitride layer.

The protic solvent may have a conductivity of 10 μS/cm or less. In some embodiments, the protic solvent may have a conductivity of 5 μS/cm or less, or 2 μS/cm or less.

The conductivity may be measured on a solution in which 1 wt % of hydrofluoric acid is dissolved in the protic solvent. The solution may include 99 wt % of the protic solvent and 1 wt % of hydrofluoric acid.

The conductivity may be measured after being calibrated with a standard solution. For example, the standard solution may be a Mettler Toledo Standard solution (1413 μS/cm).

The conductivity may be measured using, for example, a conductivity meter (Mettler Toledo, DLS-0005), and the measurement may be performed at room temperature, for example, 25° C.

When the conductivity of the protic solvent is within the above range, the ionization of hydrofluoric acid may be reduced, thereby suppressing the formation of HF₂⁻ which etches the silicon oxide layer.

The protic solvent may have a boiling point of 80° C. or higher. Accordingly, an amount of volatilization of the protic solvent during the etching process may be small, and it is possible to prevent a problem that the stability of the etching process is decreased due to a large change in a component ratio of the composition during the process.

The boiling point of the protic solvent may be selected in consideration of the temperature of the environment where the etching process is performed. For example, the boiling point of the protic solvent may be 30° C. or higher than the temperature of the environment where the etching process is performed.

The protic solvent may include an alcohol solvent. The alcohol solvent may satisfy the above range in the conductivity and boiling point while also having high polarity. In some embodiments, the alcohol solvent may be an alcohol solvent having 3 or more carbon atoms, and may be a polyhydric alcohol.

The protic solvent may be, for example, glycols such as ethylene glycol, propylene glycol, butyl glycol, glycerol, propylene glycol monomethyl ether, propanol, butanol, hexanol, 2-methylhydroxyisobutyrate, etc. These may be used alone or in combination of two or more thereof.

The content of the protic solvent may be a balance with respect to the content of other components of the composition. The balance may mean a remaining amount for controlling the content of other components based on 100 wt % of the composition.

For example, the content of the protic solvent may be 84 wt % or more and less than 98.5 wt % based on the total weight of the composition.

The water may be included in a small amount in order to dissolve hydrofluoric acid in the composition. Accordingly, the etching rate for the silicon nitride layer of the composition may be increased.

A content of the water may be 0.5 to 10 wt % based on the total weight of the composition. In some embodiments, the content of the water may be 1 to 5 wt %. Within the above range, the solubility of the hydrofluoric acid may be increased to secure an appropriate etching process rate while preventing excessive ionization of the hydrofluoric acid thus to prevent etching of the silicon oxide layer.

According to exemplary embodiments, the water may be ultrapure water.

According to exemplary embodiments, the hydrofluoric acid may be used in an aqueous solution state to prepare the composition.

According to exemplary embodiments, a ratio of the content of hydrofluoric acid to the content of water in the total weight of the composition may be 0.1 to 2. According to some embodiments, the ratio of the content of hydrofluoric acid to the content of water in the total weight of the composition may be 0.2 to 2.

Within the above range, the excessive ionization of the hydrofluoric acid may be prevented, thereby further preventing the etching of the silicon oxide layer, while increasing the solubility of the hydrofluoric acid to secure an appropriate etching process rate.

According to exemplary embodiments, the composition may not further include other acidic compounds. The acidic compound is a compound different from the hydrofluoric acid, the boron-containing compound and the phosphite compound, and may include, for example, an inorganic acid such as sulfuric acid, nitric acid, or hydrochloric acid, etc., or an organic acid such as acetic acid, etc.

The composition may not include other acidic compounds, such that an etching mechanism for the silicon nitride layer of the hydrofluoric acid may not be interfered by other side reactions.

According to exemplary embodiments, the composition may not include a silicon compound. The silicon compound may include a linear or cyclic organic compound including at least one silicon atom.

According to exemplary embodiments, the composition may not include a basic compound. The basic compound may include an organic basic compound or an inorganic basic compound.

For example, the organic basic compound may include one of a quaternary alkyl ammonium salt compound, an azabicyclo compound, a diazabicyclo compound and a triazabicyclo compound.

The quaternary alkyl ammonium salt compound may include at least one selected from the group consisting of ammonium hydroxide, tetramethylammonium hydroxide, tetraethylammonium hydroxide, tetrapropylammonium hydroxide, tetrabutylammonium hydroxide, tetrahexylammonium hydroxide, tetraoctylammonium hydroxide, benzyltriethylammonium hydroxide, diethyldimethylammonium hydroxide and methyltributylammonium hydroxide.

The inorganic basic compound may include metal hydroxides such as lithium hydroxide, sodium hydroxide, potassium hydroxide, rubidium hydroxide, cesium hydroxide and francium hydroxide, etc.

The composition may further include conventional additives in addition to the above-described components, and the additives may include corrosion inhibitors, etc. In addition, the additives are not limited thereto, and various other additives known in the art may be selected and added.

According to exemplary embodiments, in a semiconductor manufacturing process, a silicon nitride layer may be selectively wet-etched using the composition in a shallow trench isolation (STI) or gate electrode forming process of a DRAM or NAND flash memory.

The etching process may be performed by a wet etching method commonly known in the art. For example, a method using immersion and/or spraying, etc. may be used.

The etching process may be performed at a relatively low temperature. For example, the etching process may be performed at a temperature of about 20° C. to 100° C., or 50° C. to 80° C. Accordingly, it is possible to prevent the etching rate of the silicon oxide layer from increasing.

In the etching process, the etching rate of the silicon nitride layer may be 1 Å/min or more. In some embodiments, the etching rate of the silicon nitride layer may be 2 Å/min or more, or 3 Å/min or more. In some embodiments, the etching rate of the silicon nitride layer may be 10 Å/min or less.

In the etching process, the etching rate of the silicon oxide layer may be less than 2 Å/min. In some embodiments, the etching rate of the silicon oxide layer may be less than 1 Å/min.

A ratio of the etching rate of the silicon nitride layer to the etching rate of the silicon oxide layer may be 2 or more. In some embodiments, the ratio of the etching rate of the silicon nitride layer to the etching rate of the silicon oxide layer may be 3 or more, or 6 or more. In some embodiments, the ratio of the etching rate of the silicon nitride layer to the etching rate of the silicon oxide layer may be 20 or less.

Within the above range, the etching rate of the silicon nitride layer is greater than the etching rate of the silicon oxide layer, and thus, a fine pattern may be formed by etching only the silicon nitride layer.

Hereinafter, with reference to specific experimental examples, examples of the present invention will be additionally described. However, the examples and comparative examples included in the experimental examples are provided for illustrative purpose only, but are not intended to limit the appended claims, and those skilled in the art will obviously understand that various alterations and modifications are possible within the scope and spirit of the present invention. Such alterations and modifications are duly included in the appended claims.

Compositions for etching a silicon nitride layer were prepared using fluorine-containing compounds, phosphorus-containing compounds, or boron-containing compounds, water and organic solvents, as respectively shown in Tables 1 and 2 below. The content of each component was shown in wt % unit based on the total weight of the composition.

Comparative Example A2 and Comparative Example B2 are the same as each other, but are inserted into both Tables 1 and 2 for comparison.

TABLE 1

| | Fluorine- | | Phosphorus- | | | | |
|---|---|---|---|---|---|---|---|
| | containing | | containing | | | | |
| | compound | | compound | | Organic solvent | | Water |
| | Type | Content | Type | Content | Type | Content | Content |
| Example A1 | A-1 | 0.3 | P-2 | 3 | C-2 | 95.7 | 1 |
| Example A2 | A-1 | 0.5 | P-2 | 3 | C-2 | 95.5 | 1 |
| Example A3 | A-1 | 1 | P-2 | 3 | C-2 | 95 | 1 |
| Example A4 | A-1 | 2 | P-2 | 3 | C-2 | 93 | 2 |
| Example A5 | A-1 | 3 | P-2 | 3 | C-2 | 91 | 3 |
| Example A6 | A-1 | 5 | P-2 | 3 | C-2 | 87 | 5 |
| Example A7 | A-1 | 7 | P-2 | 3 | C-2 | 83 | 7 |
| Example A8 | A-1 | 1 | P-2 | 0.5 | C-2 | 97.5 | 1 |
| Example A9 | A-1 | 1 | P-2 | 1 | C-2 | 97 | 1 |
| Example A10 | A-1 | 1 | P-2 | 2 | C-2 | 96 | 1 |
| Example A11 | A-1 | 1 | P-2 | 4 | C-2 | 94 | 1 |
| Example A12 | A-1 | 1 | P-2 | 6 | C-2 | 92 | 1 |
| Example A13 | A-1 | 1 | P-2 | 8 | C-2 | 90 | 1 |
| Example A14 | A-1 | 1 | P-2 | 3 | C-1 | 95 | 1 |
| Example A15 | A-1 | 1 | P-2 | 3 | C-3 | 95 | 1 |
| Example A16 | A-1 | 1 | P-2 | 3 | C-4 | 95 | 1 |
| Example A17 | A-1 | 1 | P-3 | 3 | C-5 | 95 | 1 |
| Example A18 | A-1 | 1 | P-1 | 3 | C-2 | 95 | 1 |
| Example A19 | A-1 | 1 | P-3 | 3 | C-2 | 95 | 1 |
| Example A20 | A-1 | 1 | P-4 | 3 | C-2 | 95 | 1 |
| Example A21 | A-1 | 1 | P-5 | 3 | C-2 | 95 | 1 |
| Example A22 | A-1 | 1 | P-6 | 3 | C-2 | 95 | 1 |
| Example A23 | A-1 | 1 | P-2 | 3 | C-2 | 95.5 | 0.5 |
| Example A24 | A-1 | 1 | P-2 | 3 | C-2 | 93 | 3 |
| Example A25 | A-1 | 1 | P-2 | 3 | C-2 | 91 | 5 |
| Example A26 | A-1 | 1 | P-2 | 3 | C-2 | 89 | 7 |
| Example A27 | A-1 | 1 | P-7 | 3 | C-2 | 95 | 1 |
| Example A28 | A-1 | 7 | P-2 | 3 | C-2 | 80 | 10 |
| Comparative | — | — | P-2 | 3 | C-2 | 96 | 1 |
| Example A1 | | | | | | | |
| Comparative | A-1 | 1 | — | — | C-2 | 98 | 1 |
| Example A2 | | | | | | | |
| Comparative | A-1 | 1 | P-2 | 3 | — | — | 96 |
| Example A3 | | | | | | | |
| Comparative | A-2 | 1 | P-2 | 3 | — | — | 96 |
| Example A4 | | | | | | | |
| Comparative | A-3 | 1 | P-2 | 3 | — | — | 96 |
| Example A5 | | | | | | | |
| Comparative | A-2 | 1 | P-2 | 3 | C-2 | 95 | 1 |
| Example A6 | | | | | | | |
| Comparative | A-3 | 1 | P-2 | 3 | C-2 | 95 | 1 |
| Example A7 | | | | | | | |
| Comparative | A-4 | 1 | P-2 | 3 | C-2 | 95 | 1 |
| Example A8 | | | | | | | |
| Comparative | A-1 | 1 | P-8 | 3 | C-2 | 95 | 1 |
| Example A9 | | | | | | | |
| Comparative | A-1 | 1 | P-3 | 3 | C-6 | 95 | 1 |
| Example A10 | | | | | | | |
| Comparative | A-1 | 1 | P-3 | 3 | C-7 | 95 | 1 |
| Example A11 | | | | | | | |

TABLE 2

| | Fluorine- | | Boron- | | | | |
|---|---|---|---|---|---|---|---|
| | containing | | containing | | Organic | | |
| | compound | | compound | | solvent | | Water |
| | Type | Content | Type | Content | Type | Content | Content |
| Example | A-1 | 0.3 | B-3 | 0.3 | C-2 | 98.4 | 1 |
| B1 | | | | | | | |
| Example | A-1 | 0.5 | B-3 | 0.3 | C-2 | 98.2 | 1 |
| B2 | | | | | | | |
| Example | A-1 | 1 | B-3 | 0.3 | C-2 | 97.7 | 1 |
| B3 | | | | | | | |
| Example | A-1 | 2 | B-3 | 0.3 | C-2 | 95.7 | 2 |
| B4 | | | | | | | |
| Example | A-1 | 3 | B-3 | 0.3 | C-2 | 93.7 | 3 |
| B5 | | | | | | | |
| Example | A-1 | 5 | B-3 | 0.3 | C-2 | 89.7 | 5 |
| B6 | | | | | | | |
| Example | A-1 | 7 | B-3 | 0.3 | C-2 | 85.7 | 7 |
| B7 | | | | | | | |
| Example | A-1 | 1 | B-3 | 0.05 | C-2 | 97.95 | 1 |
| B8 | | | | | | | |
| Example | A-1 | 1 | B-3 | 0.1 | C-2 | 97.9 | 1 |
| B9 | | | | | | | |
| Example | A-1 | 1 | B-3 | 1 | C-2 | 97 | 1 |
| B10 | | | | | | | |
| Example | A-1 | 1 | B-3 | 3 | C-2 | 95 | 1 |
| B11 | | | | | | | |
| Example | A-1 | 1 | B-3 | 5 | C-2 | 93 | 1 |
| B12 | | | | | | | |
| Example | A-1 | 1 | B-3 | 0.3 | C-1 | 97.7 | 1 |
| B13 | | | | | | | |
| Example | A-1 | 1 | B-3 | 0.3 | C-3 | 97.7 | 1 |
| B14 | | | | | | | |
| Example | A-1 | 1 | B-3 | 0.3 | C-4 | 97.7 | 1 |
| B15 | | | | | | | |
| Example | A-1 | 1 | B-1 | 0.3 | C-2 | 97.7 | 1 |
| B16 | | | | | | | |
| Example | A-1 | 1 | B-2 | 0.3 | C-2 | 97.7 | 1 |
| B17 | | | | | | | |
| Example | A-1 | 1 | B-4 | 0.3 | C-2 | 97.7 | 1 |
| B18 | | | | | | | |
| Example | A-1 | 1 | B-5 | 0.3 | C-2 | 97.7 | 1 |
| B19 | | | | | | | |
| Example | A-1 | 1 | B-6 | 0.3 | C-2 | 97.7 | 1 |
| B20 | | | | | | | |
| Example | A-1 | 1 | B-3 | 0.3 | C-2 | 98.2 | 0.5 |
| B21 | | | | | | | |
| Example | A-1 | 1 | B-3 | 0.3 | C-2 | 95.7 | 3 |
| B22 | | | | | | | |
| Example | A-1 | 1 | B-3 | 0.3 | C-2 | 93.7 | 5 |
| B23 | | | | | | | |
| Example | A-1 | 1 | B-3 | 0.3 | C-2 | 91.7 | 7 |
| B24 | | | | | | | |
| Example | A-1 | 1 | B-3 | 0.3 | C-5 | 97.7 | 1 |
| B25 | | | | | | | |
| Example | A-1 | 1 | B-7 | 0.3 | C-2 | 97.7 | 1 |
| B26 | | | | | | | |
| Example | A-1 | 7 | B-3 | 0.3 | C-2 | 80 | 12.7 |
| B27 | | | | | | | |
| Compar- | — | — | B-3 | 0.3 | C-2 | 98.7 | 1 |
| ative | | | | | | | |
| Example | | | | | | | |
| B1 | | | | | | | |
| Compar- | A-1 | 1 | — | — | C-2 | 98 | 1 |
| ative | | | | | | | |
| Example | | | | | | | |
| B2 | | | | | | | |
| Compar- | A-1 | 1 | B-3 | 0.3 | — | — | 98.7 |
| ative | | | | | | | |
| Example | | | | | | | |
| B3 | | | | | | | |
| Compar- | A-2 | 1 | B-3 | 0.3 | — | — | 98.7 |
| ative | | | | | | | |
| Example | | | | | | | |
| B4 | | | | | | | |
| Compar- | A-3 | 1 | B-3 | 0.3 | — | — | 98.7 |
| ative | | | | | | | |
| Example | | | | | | | |
| B5 | | | | | | | |
| Compar- | A-2 | 1 | B-3 | 0.3 | C-2 | 97.7 | 1 |
| ative | | | | | | | |
| Example | | | | | | | |
| B6 | | | | | | | |
| Compar- | A-3 | 1 | B-3 | 0.3 | C-2 | 97.7 | 1 |
| ative | | | | | | | |
| Example | | | | | | | |
| B7 | | | | | | | |
| Compar- | A-4 | 1 | B-3 | 0.3 | C-2 | 97.7 | 1 |
| ative | | | | | | | |
| Example | | | | | | | |
| B8 | | | | | | | |
| Compar- | A-1 | 1 | B-3 | 0.3 | C-6 | 97.7 | 1 |
| ative | | | | | | | |
| Example | | | | | | | |
| B9 | | | | | | | |
| Compar- | A-1 | 1 | B-3 | 0.3 | C-7 | 97.7 | 1 |
| ative | | | | | | | |
| Example | | | | | | | |
| B10 | | | | | | | |

A-1: Hydrofluoric acid
A-2: Ammonium fluoride
A-3: Tetrabutylammonium fluoride
A-4: Sodium fluoride
P-1: Trimethyl phosphite
P-2: Triethyl phosphite
P-3: Triisopropyl phosphite
P-4: Tributyl phosphite
P-5: Triphenyl phosphite
P-6: Tris(nonylphenyl) phosphite
P-7: Methyldiethyl phosphite
P-8: Triethyl phosphate
B-1: Boric acid
B-2: Trimethyl borate
B-3: Triethyl borate
B-4: Triisopropyl borate
B-5: Triphenyl borate
B-6: Sodium borohydride
B-7: Methyldiethyl borate
C-1: Ethylene glycol (boiling point: 197° C., conductivity: 1.8 μS/cm)
C-2: Propylene glycol monomethyl ether (boiling point: 120° C., conductivity: 1.4 μS/cm)
C-3: Glycerol (boiling point: 290° C., conductivity: 8.5 μS/cm)
C-4: Butanol (boiling point: 118° C., conductivity: 7.8 μS/cm)
C-5: Ethanol (boiling point: 78° C., conductivity: 11.7 μS/cm)
C-6: Dimethyl sulfoxide (boiling point: 189° C., conductivity: 0.8 μS/cm)
C-7: Acetic anhydride (boiling point: 140° C., conductivity: 1.1 μS/cm)
Water: Ultrapure water (boiling point: 100° C., conductivity: 12700 μS/cm)
The conductivities of the C-1 to C-7 and water were measured by the following method: The solutions including 99 wt % of the C-1 to C-7, water and 1 wt % of hydrofluoric acid were subjected to calibration with a standard solution (Mettler Toledo Standard solution 1413 uS/cm), then the conductivities were measured at 25° C. using a conductivity meter (Mettler Toledo, DLS-0005).

### EXPERIMENTAL EXAMPLE

A wafer having a silicon oxide layer formed on the surface thereof or a wafer having a silicon nitride layer formed on the surface thereof was cut into a size of 1.5×1.5 cm² to prepare a specimen. The specimen was treated with diluted hydrofluoric acid (DHF, 100 parts by weight (“wt. parts”) of water and 1 wt. part of HF) at room temperature for 1 minute to remove contaminants from the surface, and then washed with water and dried. Thereafter, initial thicknesses of the silicon oxide layer and the nitride layer were measured using ellipsometry equipment.

The specimen was immersed in the etchant compositions of the examples and comparative examples under conditions of 70° C. and 400 rpm for 10 minutes. The specimen was taken out, washed with ultrapure water, and dried in the air. Then, the thicknesses of the silicon oxide layer and the nitride layer after etching were measured using the ellipsometry equipment, and the etching amount was calculated from a difference between the initial thickness and the thickness after etching.

At this time, the etching amounts of the silicon nitride layer and the silicon oxide layer were evaluated according to the following standards, and the selectivity was shown by calculating the ratio of the etching amount of the silicon oxide layer to the etching amount of the silicon nitride layer. Results thereof are listed in Tables 3 and 4 below.

### Evaluation Standards for Silicon Nitride Layer Etching Amount

⊚: Etching amount 30 Å or more
∘: Etching amount less than 30 Å to 20 Å or more
Δ: Etching amount less than 20 Å to 10 Å or more
X: Etching amount less than 10 Å

### Evaluation Standards for Silicon Oxide Layer Etching Amount

⊚: Etching amount less than 10 Å
∘: Etching amount 10 Å or more to less than 20 Å
Δ: Etching amount 20 Å or more to less than 50 Å
X: Etching amount 50 Å or more

### Evaluation of Silicon Oxide Layer/Silicon Nitride Layer Selectivity

⊚: Selectivity 6.0 or more
∘: Selectivity 3.0 or more to less than 6.0
Δ: Selectivity 2.0 or more to less than 3.0
X: Selectivity less than 2.0

TABLE 3

| | Silicon nitride layer | Silicon oxide layer | |
|---|---|---|---|
| | etching amount | etching amount | Selectivity |
| Example A1 | Δ | ⊚ | Δ |
| Example A2 | ◯ | ⊚ | ◯ |
| Example A3 | ⊚ | ⊚ | ⊚ |
| Example A4 | ⊚ | ⊚ | ⊚ |
| Example A5 | ⊚ | ⊚ | ⊚ |
| Example A6 | ⊚ | ⊚ | ◯ |
| Example A7 | ⊚ | ◯ | Δ |
| Example A8 | ⊚ | ◯ | Δ |
| Example A9 | ⊚ | ◯ | ◯ |
| Example A10 | ⊚ | ⊚ | ◯ |
| Example A11 | ⊚ | ⊚ | ⊚ |
| Example A12 | ◯ | ⊚ | ◯ |
| Example A13 | Δ | ⊚ | Δ |
| Example A14 | ⊚ | ⊚ | ⊚ |
| Example A15 | ⊚ | ◯ | ◯ |
| Example A16 | ⊚ | ⊚ | ⊚ |
| Example A17 | ⊚ | Δ | Δ |
| Example A18 | ⊚ | ◯ | ⊚ |
| Example A19 | ⊚ | ⊚ | ⊚ |
| Example A20 | ⊚ | ◯ | ⊚ |
| Example A21 | Δ | ⊚ | Δ |
| Example A22 | Δ | ⊚ | Δ |
| Example A23 | ◯ | ⊚ | ⊚ |
| Example A24 | ⊚ | ⊚ | ⊚ |
| Example A25 | ⊚ | ◯ | ◯ |
| Example A26 | ⊚ | ◯ | Δ |
| Example A27 | ⊚ | ⊚ | ⊚ |
| Example A28 | ⊚ | Δ | Δ |
| Comparative | X | ⊚ | X |
| Example A1 | | | |
| Comparative | ⊚ | Δ | X |
| Example A2 | | | |
| Comparative | ⊚ | X | X |
| Example A3 | | | |
| Comparative | ⊚ | X | X |
| Example A4 | | | |
| Comparative | ⊚ | X | X |
| Example A5 | | | |
| Comparative | X | ⊚ | X |
| Example A6 | | | |
| Comparative | X | ⊚ | X |
| Example A7 | | | |
| Comparative | X | ⊚ | X |
| Example A8 | | | |
| Comparative | ⊚ | Δ | X |
| Example A9 | | | |
| Comparative | X | ⊚ | X |
| Example A10 | | | |
| Comparative | X | ⊚ | X |
| Example A11 | | | |

TABLE 4

| | Silicon nitride layer | Silicon oxide layer | |
|---|---|---|---|
| | etching amount | etching amount | Selectivity |
| Example B1 | Δ | ⊚ | Δ |
| Example B2 | ◯ | ⊚ | ◯ |
| Example B3 | ⊚ | ⊚ | ⊚ |
| Example B4 | ⊚ | ⊚ | ⊚ |
| Example B5 | ⊚ | ⊚ | ⊚ |
| Example B6 | ⊚ | ⊚ | ◯ |
| Example B7 | ⊚ | ◯ | Δ |
| Example B8 | ⊚ | ◯ | Δ |
| Example B9 | ⊚ | ◯ | ◯ |
| Example B10 | ⊚ | ⊚ | ⊚ |
| Example B11 | ◯ | ⊚ | ◯ |
| Example B12 | Δ | ⊚ | Δ |
| Example B13 | ⊚ | ⊚ | ⊚ |
| Example B14 | ⊚ | ◯ | ◯ |
| Example B15 | ⊚ | ⊚ | ⊚ |
| Example B16 | ⊚ | ◯ | ⊚ |
| Example B17 | ⊚ | ⊚ | ⊚ |
| Example B18 | ⊚ | ◯ | ⊚ |
| Example B19 | Δ | ⊚ | Δ |
| Example B20 | ◯ | Δ | Δ |
| Example B21 | ◯ | ⊚ | ⊚ |
| Example B22 | ⊚ | ⊚ | ⊚ |
| Example B23 | ⊚ | ◯ | ◯ |
| Example B24 | ⊚ | ◯ | Δ |
| Example B25 | ⊚ | Δ | X |
| Example B26 | ⊚ | ⊚ | ⊚ |
| Example B27 | ⊚ | Δ | Δ |
| Comparative | X | ⊚ | X |
| Example B1 | | | |
| Comparative | ⊚ | Δ | X |
| Example B2 | | | |
| Comparative | ⊚ | X | X |
| Example B3 | | | |
| Comparative | ⊚ | X | X |
| Example B4 | | | |
| Comparative | ⊚ | X | X |
| Example B5 | | | |
| Comparative | X | ⊚ | X |
| Example B6 | | | |
| Comparative | X | ⊚ | X |
| Example B7 | | | |
| Comparative | X | ⊚ | X |
| Example B8 | | | |
| Comparative | X | ⊚ | X |
| Example B9 | | | |
| Comparative | X | ⊚ | X |
| Example B10 | | | |

Referring to Tables 3 and 4 above, by using the compositions of the examples, the silicon oxide was hardly etched or was etched in relatively small quantities while the silicon nitride layer was etched in a large quantity. Accordingly, it was confirmed that the compositions of the examples had high silicon nitride layer etching selectivity.

The compositions of Comparative Examples A1, A6 to A8, B1, and B6 to B8 did not include hydrofluoric acid, such that both the silicon oxide layer and the silicon nitride layer were etched in a small quantity. Accordingly, the selectivity was decreased than that of the compositions of the examples.

The composition of Comparative Example A2 (or Comparative Example B2) did not include a phosphite compound or boron-containing compound, such that the silicon oxide layer was etched in a relatively large quantity, and the selectivity was decreased than that of the compositions of the examples.

The compositions of Comparative Examples A3 to A5 and B3 to B5 included water as a solvent instead of the protic solvent. Accordingly, both the silicon nitride layer and the silicon oxide layer were etched in a large quantity, and the selectivity was decreased than that of the compositions of the examples.

The composition of Comparative Example A9 included a phosphate compound instead of the phosphite compound. Accordingly, the silicon oxide layer was etched in a relatively large quantity, and the selectivity was decreased than that of the compositions of the examples.

The compositions of Comparative Examples A10 and A11 and Comparative Examples B9 and B10 included an aprotic solvent. Accordingly, both the silicon oxide layer and the silicon nitride layer were etched in a small quantity. Accordingly, the selectivity was decreased than that of the compositions of the examples.

The contents described above are merely an example of applying the principle of the present disclosure, and other configurations may be further included without departing from the scope of the present invention.

What is claimed is:

1. A composition for etching a silicon nitride layer, the composition comprising:
hydrofluoric acid;
a boron-containing compound or a phosphite compound;
water; and
a protic solvent.

2. The composition of claim 1, wherein the composition includes the phosphite compound represented by Formula 1 below: 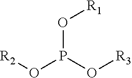
wherein R₁ to R₃ are each independently hydrogen, an alkyl group having 1 to 10 carbon atoms, an aryl group having 6 to 10 carbon atoms, or an alkylaryl group having 7 to 20 carbon atoms.

3. The composition of claim 2, wherein R₁ to R₃ are each independently hydrogen or an alkyl group having 1 to 4 carbon atoms.

4. The composition of claim 2, wherein R₁ to R₃ are the same as each other.

5. The composition of claim 1, wherein the composition includes the phosphite compound, and a content of the phosphite compound is 0.1% by weight to 10% by weight based on a total weight of the composition.

6. The composition of claim 1, wherein the composition includes the phosphite compound, and a content of the phosphite compound is 0.5% by weight to 5% by weight based on a total weight of the composition.

7. The composition of claim 1, wherein the composition includes the boron-containing compound comprising a borate compound.

8. The composition of claim 1, wherein the composition includes the boron-containing compound represented by Formula 2: 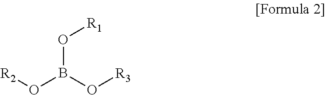
wherein, in Formula 2, R₁ to R₃ are each independently hydrogen, an alkyl group having 1 to 10 carbon atoms, or an aryl group having 6 to 10 carbon atoms.

9. The composition of claim 8, wherein, in the Formula 2, R₁ to R₃ are each independently hydrogen or an alkyl group having 1 to 4 carbon atoms.

10. The composition of claim 8, wherein, in the Formula 2, R₁ to R₃ are the same as each other.

11. The composition of claim 1, wherein a content of the boron-containing compound is 0.01% by weight to 5% by weight based on a total weight of the composition.

12. The composition of claim 1, wherein the composition includes the boron-containing compound, and a content of the boron-containing compound is 0.1% by weight to 3% by weight based on a total weight of the composition.

13. The composition of claim 1, wherein the protic solvent has a conductivity of 10 μS/cm or less, and
the conductivity is measured on a solution in which 1% by weight of hydrofluoric acid is dissolved in the protic solvent.

14. The composition of claim 1, wherein the protic solvent has a boiling point of 80° C. or higher.

15. The composition of claim 1, wherein the protic solvent comprises an alcohol solvent.

16. The composition of claim 1, wherein a content of the hydrofluoric acid is 0.1% by weight to 10% by weight based on a total weight of the composition.

17. The composition of claim 1, wherein a content of the water is 0.5% by weight to 10% by weight based on a total weight of the composition.

18. The composition of claim 1, wherein a ratio of a content of hydrofluoric acid to a content of water in the total weight of the composition is 0.1 to 1.5.

19. The composition of claim 1, wherein the composition does not include a silicon compound.

20. The composition of claim 1, wherein the composition does not include a basic compound.
